(19) United States
(12) Patent Application Publication
(10) Pub. No.: US 2004/0156999 A1
(43) Pub. Date: Aug. 12, 2004

(54) Black trivalent chromium chromate conversion coating

(75) Inventors: Clifford F. Biddulph, North Olmsted, OH (US); Leonard L. Diaddario JR., Independence, OH (US); Michael Marzano, Concord, OH (US); Antonino Oriti III, Mayfield Heights, OH (US)

Correspondence Address: Scott A. McCollister, Esq., Fay, Sharpe, Fagan, Minnich & McKee, LLP, Seventh Floor, 1100 Superior Avenue, Cleveland, OH, 44114-2518, US

(73) Assignee: Pavco, Inc.

(21) Appl. No.: 10/774,559

(22) Filed: Feb. 9, 2004

Related U.S. Application Data
(60) Provisional application No. 60/445,608, filed on Feb. 7, 2003.

(51) Int. Cl. B05D 1/18; C23C 18/31; C23C 18/48

(52) U.S. Cl. 427/436; 106/1.25; 106/1.27; 106/1.28

(57) ABSTRACT

A composition and method for providing a blank chromate conversion coating is provided. The composition is substantially free of hexavolent chromium and provides a black finish, on zinc or zinc alloy coatings. The composition includes trivalent chromium ions, phosphorous anions, anions selected from the group consisting of sulfate ions, nitrate ions and combinations thereof, at least one of a transition metal or metalloid from Groups III, IVa, Va or VIII, and an organic chelate selected from the group consisting of carboxylic acids, polycarboxylic acids and combinations thereof.

This application claims priority under 35 U.S.C. §119(e) to provisional application 60/445,608, filed on Feb. 7, 2003.

### FIELD OF THE INVENTION

The present invention relates to chromate conversion coatings employing trivalent chromium. Specifically, the invention relates to trivalent chromium conversion coatings that are free of hexavalent chromium and provide a black chromate coating.

### BACKGROUND

Metal substrates are generally coated or plated with a metal such as, for example, zinc, to provide both a decorative finish and/or corrosion protection of the base metal substrate. Further corrosion resistance can be provided by subjecting the surfaces of the zinc coated object to a passivating solution containing chromic acid. The resulting chromate conversion coatings are formed by the precipitation of a thin chromium complex that is composed of chromium ions and the coating metal. The precipitation of the chromium gel results from the coated metal surface dissolving to a small extent, which causes a pH increase at the surface-liquid interface.

Chromate conversion coatings, while providing additional corrosion resistance, also provide a decorative finish. Chromate conversion coatings may provide a variety of color coatings including blue, yellow, olive, or black, as well as providing a base for dyeing operations.

Traditionally, hexavalent chromium (Cr⁶⁺ or chromium(VI)) supplied the chromium ions for chromate conversion coatings. The use of hexavalent chromium conversion coatings to produce a black finish on zinc deposits is known. Such solutions typically contain silver, copper, selenium and other metals to produce the black chromate coating.

Several problems, however, are associated with hexavalent chromium. Hexavalent chromium is toxic, and, thus, the use of such solutions presents serious health and environmental hazards. Consequently, the use of hexavalent chromium in chromate conversion coatings results in hazardous and expensive waste treatment of such solutions. Further, various industry regulations, such as in the automotive industry, have placed restrictions on the amount of hexavalent chrome that is allowed in certain products. It is, therefore, desirable to provide conversion coatings that contain either minimal amounts of or no hexavalent chromium.

The use of trivalent chromium in chromate conversion coatings is known in the art. Chromate conversion coatings based on trivalent chromium offer an advantage over hexavalent chromium conversion coatings in that trivalent chromium is not toxic. Additionally, waste removal of trivalent chromium is not as expensive as waste removal of hexavalent chromium.

Chromate conversion coatings that are substantially free of hexavalent chromate and produce clear, blue or iridescent finishes have been described. It is also, however, desirable to provide a chromate conversion coating free of hexavalent chromium that provides a black finish.

### SUMMARY OF THE INVENTION

Accordingly, it is an object of the invention to provide a chromate conversion coating free of hexavalent chromium. It is a further object of this invention to provide a chromate conversion coating free of hexavalent chromium that provides a black finish. It is still another object of the invention to provide a method for coating a zinc or zinc alloy deposit with a black chromate conversion coating.

According to one embodiment, an aqueous acidic chromate conversion coating is provided which is free of hexavalent chromium, for depositing a coating having a black finish on zinc or zinc alloys comprising trivalent chromium ions in a concentration of about 0.02M to about 0.2M; phosphorous anions; anions selected from the group of sulfate ions, nitrate ions, and combinations thereof; one or more transition metals or one or more of the metalloids from Groups IIIa, IVa, Va, or VIII and an organic chelate selected from the group consisting of carboxylic acids, polycarboxylic acids, and combinations thereof.

In a related embodiment, a method is provided for forming a black trivalent chromium chromate conversion coating on zinc or zinc alloys comprising forming a zinc or zinc alloy coating on a substrate; immersing the zinc or zinc alloy coating in a aqueous acidic chromate solution having a pH of about 0.5 to about 3.5; trivalent chromium ions in a concentration of about 0.02M to about 0.2M; phosphorous anions; anions selected from the group of sulfate ions, nitrate ions, and combinations thereof; at least one transition metal or metalloid selected from groups III, IVa, Va, or VIII, and an organic chelate selected from the group consisting of carboxylic acids, polycarboxylic acids, and combinations thereof; and drying the zinc or zinc alloy coating to which the black trivalent chromium chromate conversion coating has been applied.

### DETAILED DESCRIPTION OF THE INVENTION

The conversion coating solutions of the invention include trivalent chromium ions, phosphorous anions, anions selected from the group consisting of sulfate ions, nitrate ions, or combinations thereof, one or more transition metals or metalloids selected from Groups IIIa, IVa, Va, or VIII, and an organic chelate.

Trivalent chromium ions may be provided by any suitable means. Trivalent chromium ions may be supplied, for example, by chromium nitrate (Cr(NO₃)₃). An additional source of trivalent chromium ions is HYPRO BLUE, a blue chromate conversion coating available from Pavco, Inc., 4450 Cranwood Parkway, Warrensville Heights, Ohio 44128. Additionally, trivalent chromium ions may be prepared by the reduction of hexavalent chromium compounds to the trivalent state. Any suitable method may be used to reduce hexavalent chromium to the trivalent state. For example, hexavalent chromium compounds such as chromic acid and sodium dichromate may be reduced to trivalent chromium by the use of reducing agents such as hydrogen peroxide, sodium metabisulfite and/or sodium nitrite.

The concentration of trivalent chromium in the chromate conversion coating solutions of the present invention is from about 0.02M to about 0.2M. Preferably, the concentration of trivalent chromium ranges from about 0.03M to about 0.07M.

The phosphorous anions of the chromate conversion coating solution are provided by phosphorous acids or salts thereof. Non-limiting examples of suitable sources of phosphorous anions include phosphoric acids, mono-sodium phosphates, mono-ammonium phosphates and mixtures thereof. The phosphorous anions in the chromate conversion coating solution are present in an amount of about 0.05M to about 0.75M.

The chromate conversion coating solutions of the present invention also include anions selected from the group consisting of sulfate ions, nitrate ions and combinations thereof. Preferably, sulfates are present in a concentration of about 0.02 to about 0.5M and nitrates are present in a concentration of about 0.06 to about 0.6M.

The chromate conversion coating solutions of the present invention may further include one or more transition metals. Any one of the transition metals selected from the Group VIII transition metals, including iron, cobalt, nickel, or copper, may be used in the solution. Typically, the transition metal will be present at a concentration of from about 0.005M to about 0.5M. Additionally, any one or more of the metalloids from the groups IIIa, IVa, or Va may be used in the chromate conversion coatings. The metalloids may be used alone or in combination with the selected grouping of transition metals in the present invention.

The organic chelates are selected from the group consisting of polycarboxylic acids and combinations thereof. Any suitable carboxylic acid or polycarboxylic acid may be used as an organic chelate in the chromate conversion coating of the present invention. Non-limiting examples of suitable carboxylic and polycarboxylic acids include citric acid, tartaric acid, malic acid, glycerinc acid, lactic acid, glycolic acid, malonic acid, succinic acid, maleic acid, oxalic acid, and glutaric acid. Typically, the carboxylic acid and/or polycarboxylic acids will be present at a concentration of from about 0.02 to about 0.3M.

The pH of the chromate conversion coating solutions is preferably from about 0.5 to about 3.5, more preferably from about 1.2 to about 2.5 and most preferably from about 1.5 to about 2.0.

The trivalent chromium chromate conversion coatings of the present invention can be employed in a method for chromating zinc or zinc alloys, which produces a black chromate conversion coating. The method includes applying a zinc or zinc alloy deposit or coating to a substrate, immersing the zinc or zinc alloy coating in a chromate conversion coating solution in accordance with the present invention, and drying the resulting zinc or zinc alloy coating to which the chromate conversion coating has been applied.

The trivalent chromium conversion coatings of the present invention are preferably applied to zinc, zinc die cast, or zinc alloys. Zinc or zinc alloy coatings may be applied to any ferrous or non-ferrous substrate by any means known to those skilled in the art, such as, for example, electrodeposition, mechanical deposition, or galvanization. For electrodeposited zinc coatings, either alkaline zinc coatings and chloride zinc coatings may be used in accordance with the present invention. Examples of suitable alloyed zinc coatings include, but are not limited to, zinc-iron, zinc-cobalt, and zinc-nickel coatings. The zinc or zinc alloy coating should have a thickness that is capable of accepting a chromate. The acidic nature of the chromate causes some of the zinc or zinc alloy coating to be stripped away during the chromating process. The zinc or zinc alloy coating should, therefore, be sufficiently thick enough to receive a chromate coating and not be completely stripped away. Preferably, the zinc or zinc alloy coating has a thickness of at least 5 microns. More preferably the zinc or zinc alloy coating has a thickness of 8-13 microns. The present invention also contemplates zinc or zinc alloy coatings with thicknesses greater than the above listed thicknesses.

In the method according to the present invention, a black trivalent chromium chromate conversion coating is applied to a zinc or zinc alloy coating by contacting the zinc or zinc alloy coating with a chromate conversion coating solution according to the present invention. Generally, the zinc or zinc alloy coating is contacted with the chromate solution by immersing the zinc or zinc alloy coating in a bath of the chromate solution. The chromate conversion coating can be operated at a temperature of about 18° C. to about 60° C. Preferably the temperature of the chromate conversion coating is from about 25° C. to about 35° C. The zinc or zinc alloy coating is immersed in the chromate conversion coating solution for a time period of about 10 to about 180 seconds. Preferably, the zinc or zinc alloy coating is immersed for a period of about 30 to about 60 seconds. During immersion into the chromate conversion coating solution, the zinc or zinc alloy coating may optionally be mechanically moved through or agitated in the solution.

After the black chromate conversion coating is applied, the now chromated zinc or zinc alloy coating is removed from the chromate conversion coating solution and dried. Drying may be accomplished by any suitable means known in the art. For example, in barrel applications chromated parts may be dried by means including, but not limited to, centrifuge drying, tumble drying or oven heating. Rack applications are typically dried by passing through or sitting in a tank through which hot air is forced. Additionally, infrared heat may be used to dry parts. Drying is accomplished at a temperature of 25-71° C. The temperature used to dry chromated parts should not exceed 82° C. Heating at temperatures above 82° C. generally causes the chromate conversion coating to dehydrate, which will cause the coating to crack and/or flake off the zinc or zinc alloy coated substrate.

Optionally, the zinc or zinc alloy coating may be subjected to a bright dip after the substrate is coated with zinc or a zinc alloy and prior to immersing the zinc or zinc alloy coated substrate in the chromate solution. A bright dip may be used to neutralize any alkalinity on the coating, or to remove any inorganic salts at the interface or organics that might be occluded in the zinc or zinc alloy coating. Generally, if a bright dip is employed, the bright dipping is accomplished utilizing a weak mineral acid. Typical bright dip solutions include 0.1-0.5% nitric acid solutions or 0.25-1.0% sulfuric acid solutions.

The trivalent chromium chromate conversion coating solution and method of applying such solution produce a conversion coating that is black in color with a flat to glossy finish. The nature of the finish depends on the substrate, the zinc or zinc alloy coating, and the immersion time in the chromate conversion coating solution. Zinc or zinc alloy coatings chromated in accordance with the present invention exhibit corrosion protection to 50-96 hours until the onset of white salt corrosion, as defined by ASTM B-201.

The conversion coating produced in accordance with the present invention may be further supplemented with other conversion coatings for both extending corrosion protection and improving the aesthetics of the finish. An example of a suitable supplemental conversion coating includes an inorganic conversion coating containing silicate. Corrosion tests in accordance with ASTM B-117 have shown that an object coated with a black trivalent chromium chromate conversion coating according to the present invention further treated with a supplemental inorganic conversion coating exhibits corrosion protection to about 120-250 hours until the onset of white salt corrosion (as defined by ASTM B-201). Additionally, the conversion coating of the invention may be supplemented with organic conversion coatings. A chromate conversion coating according to the present invention, which is supplemented with an organic conversion coating, exhibits corrosion protection to 120-250 hours until the onset of white salt corrosion, as defined by ASTM B-201. Supplemental conversion coatings may be applied by any suitable means, including by dipping, spraying, electrocoating or powder coating. Any suitable supplemental coating may be utilized in the present invention. Dip or spray coatings may be, but are not limited to, acrylics, latexes, alkyds and the like. Dip or spray coatings may be water based or solvent based, and either air dry-able or of the bake-able cross-linking type. Electrocoat supplemental coatings may be, but are not limited to, anodic, cathodic, pigmented, clear, bake-able, or spin dry coatings.

The following examples are illustrative of black trivalent chromium conversion coating solutions according to the present invention and the appearance of substrates coated with such solutions.

### EXAMPLES

In the following examples, zinc was deposited onto a substrate to form a zinc coating. Both Hull Cell panels and Q-panels were used as the substrates. A zinc or zinc alloy was plated onto the substrate utilizing either an alkaline zinc or zinc-alloy plating bath, or a chloride zinc or zinc-alloy plating bath to form a zinc or zinc alloy coating. The substrates were plated for a period of time sufficient to deposit a zinc or zinc alloy coating having a thickness of about 5-13 microns.

Following the zinc deposition, the panels were then rinsed and subsequently immersed into the chromate conversion coating solutions of the respective examples.

| | Chromate | | |
|---|---|---|---|
| Example | Conversion Coating Solution | | Results |
| 1 | 3% | Cr(NO₃)₃ solution (3.4 M) | dark |
| | 10 g/L | CoSO₄ | gray |
| | 1% | Phosphoric acid (85% H₃PO₄) | finish |
| | 10% | NiSO₄ solution (800 g/L | |
| | | crystalline solid) | |
| 2 | 3% | Cr(NO₃)₃ solution (3.4 M) | gloss |
| | 10 g/L | CoSO₄ | black |
| | 0.5-1% | Phosphoric acid (85% H₃PO₄) | finish |
| | 3-10% | FeSO₄ solution (200 g/L | |
| | | crystalline solid) | |
| 3 | 10% | HYPRO BLUE | glossy dark |
| | 25 g/L | Sodium nitrate | green to |
| | 1% | Phosphoric acid (85% H₃PO₄) | dark black |
| | 1-2% | CuSO₄ solution (32 g/L | finish |
| | | crystalline solid) | |
| 4 | 10% | HYPRO BLUE | glossy gray |
| | 25 g/L | Sodium nitrate | with some |
| | 1% | Phosphoric acid (85% H₃PO₄) | iridescence |
| | 3-8% | FeSO₄ solution (200 g/L | at low levels |
| | | crystalline solid) | of phosphoric |
| | | | as iron and |
| | | | phosphoric |
| | | | are |
| | | | increased |
| | | | finish gets |
| | | | darker |
| | | | without |
| | | | iridescence |

Thus, it is apparent that there has been provided a trivalent chromium chromate conversion coating, which is free of hexavalent chromium, that provides a black chromate conversion coating on a zinc or zinc alloy coated substrate. Further, there has been provided a method for producing a black chromate conversion coating on zinc or zinc alloy coatings which employs the trivalent chromium conversion coating according to the present invention. While the invention has been described in conjunction with specific embodiments thereof, it is evident that many alternatives, modifications, and variations will be apparent to those skilled in the art in light of the foregoing description. Accordingly, the foregoing description is intended to embrace all such alternatives, modifications, and variations which fall within the spirit and scope of the appended claims.

What is claimed is:

1. An aqueous acidic solution that provides a black chromate conversion coating on zinc and zinc alloys comprising:
trivalent chromium ions in a concentration of about 0.02M to about 0.2M;
phosphorous anions;
anions selected from the group of sulfate ions, nitrate ions, and combinations thereof;
at least one transition metal or metalloid selected from groups III, IVa, Va, or VIII; and
an organic chelate selected from the group consisting of carboxylic acids, polycarboxylic acids, and combinations thereof.

2. The solution of claim 1, wherein the concentration of trivalent chromium ions is from about 0.03M to about 0.07M.

3. The solution of claim 1, wherein the phosphorous anions are present in a concentration of from about 0.05M to about 0.75M.

4. The solution of claim 1, wherein the phosphorous anions are provided by phosphorous acids or salts thereof selected from the group consisting of phosphoric acid, mono-sodium -phosphate, mono-ammonium phosphate and mixtures thereof.

5. The solution of claim 1, wherein the solution comprises a transition metal selected from the group consisting of iron, cobalt, nickel, copper and combinations thereof.

6. The solution of claim 5, wherein the transition metal is present at a concentration of from about 0.005M to about 0.5M.

7. The solution of claim 1, wherein the organic chelate is present in a concentration of from about 0.02M to about 0.3M.

8. The solution of claim 1, wherein the organic chelate is a carboxylic acid or polycarboxylic acid selected from the group consisting of citric acid, tartaric acid, malic acid, glyceric acid, lactic acid, glycolic acid, malonic acid, succinic acid, maleic acid, oxalic acid, flutaric acid, and combinations thereof.

9. The solution of claim 1, wherein the solution has a pH of about 0.5 to about 3.5.

10. A method for forming a black trivalent chromium chromate conversion coating on zinc or zinc alloys comprising:
forming a zinc or zinc alloy coating on a substrate;
immersing the zinc or zinc alloy coating in a aqueous acidic chromate solution having pH of about 0.5 to about 3.5; trivalent chromium ions in a concentration of about 0.02M to about 0.2M; phosphorous anions; anions selected from the group of sulfate ions, nitrate ions, and combinations thereof; at least one transition metal or metalloid selected from groups III, IVa, Va; or VIII; and an organic chelate selected from the group consisting of carboxylic acids, polycarboxylic acids, and combinations thereof; and
drying the zinc or zinc alloy coating to which the black trivalent chromium chromate conversion coating has been applied.

11. The method according to claim 10, wherein the concentration of the trivalent chromium ions is from about 0.03M to about 0.07M.

12. The method according to claim 10, wherein the phosphorous antoms are present in a concentration of from about 0.05M to about 0.75M.

13. The method according to claim 10, wherein the chromate solution comprises a transition metal selected from the group consisting of iron, cobalt, nickel, copper and combinations thereof.

14. The method according to claim 13, wherein the transition metal is present at a concentration of from about 0.005M to about 0.5M.

15. The method according to claim 10, wherein the organic chelate is present in a concentration of from about 0.02M to about 0.3M.

16. The method according to claim 10, wherein the chromate solution has a pH of about 1.2 to about 2.5.

17. The method according to claim 10, wherein the chromate solution has a pH of about 1.5 to about 2.0.

18. The method according to claim 10, wherein the temperature of the chromate solution is from about 18° C. to about 60° C.

19. An acidic chromate solution for forming a blank chromate conversion coating comprising:
trivalent chromium ions in a concentration of from about 0.02M to about 0.2M;
phosphorous anions in a concentration of from about 0.05M to about 0.75M;
anions selected from the group consisting of sulfate ions, nitrate ions, and combinations thereof;
a metal selected from the group consisting of iron, cobalt, nickel, copper and combinations thereof; and
an organic chelate selected from the group consisting of carboxylic acids and polycarboxylic acids, the organic chelate being present in an amount of from about 0.02M to about 0.3M.

20. An aqueous acidic solution that provides a black chromate conversion coating on zinc and zinc alloys comprising:
trivalent chromium ions in a concentration of about 0.02M to about 0.2M;
phosphorous anions;
anions selected from the group of sulfate ions, nitrate ions, and combinations thereof; and
at least one transition metal or metalloid selected from groups III, IVa, Va, or VIII.
